(19) United States
(12) Patent Application Publication
(10) Pub. No.: US 2014/0128296 A1
(43) Pub. Date: May 8, 2014

(54) TUNABLE POLYMERIC SURFACTANTS FOR MOBILIZING OIL INTO WATER

(71) Applicant: Soane Energy, LLC, Cambridge, MA (US)

(72) Inventors: David S. Soane, Chestnut Hill, MA (US); Robert P. Mahoney, Newbury, MA (US); Rosa Casado Portilla, Peabody, MA (US)

(73) Assignee: Soane Energy, LLC, Cambridge, MA (US)

(21) Appl. No.: 14/045,271

(22) Filed: Oct. 3, 2013

Related U.S. Application Data
(63) Continuation of application No. 12/908,401, filed on Oct. 20, 2010, now abandoned.

(51) Int. Cl. C08F 222/06; C08G 73/10; E21B 43/16; C08G 73/00

(52) U.S. Cl. CPC C08F 222/06; C08G 73/00; C08G 73/10; E21B 43/16
USPC 507/260; 510/188; 525/327.6; 525/540; 134/22.19; 134/10; 166/279

(57) ABSTRACT

The present invention relates to compositions comprising tunable polymeric surfactants and methods for enhanced oil recovery.

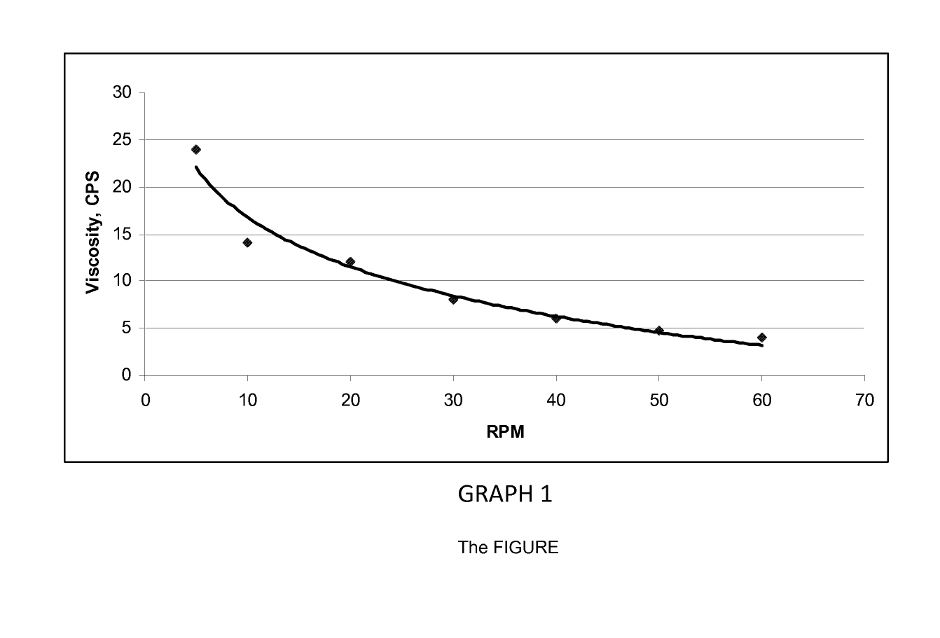

### RELATED APPLICATIONS

This application is a continuation of U.S. application Ser. No. 12/908,401, filed Oct. 20, 2010, which claims the benefit of U.S. Provisional Application Nos. 61/253,340, 61/253,451, and 61/253,363, all filed on Oct. 20, 2009. The entire teachings of the above applications are incorporated herein by reference.

### FIELD OF APPLICATION

This application relates generally to surfactant formulations and methods useful in the petroleum industry.

### BACKGROUND

Engineered formation of emulsions and demulsification technologies have a number of applications in industrial processing. In the petroleum industry, emulsified systems can interfere with oil recovery operations and waste oil management. For example, during crude oil processing, water or brine can become emulsified in oil, stabilized by naturally occurring surfactants (e.g., naphthenic acids, asphaltenes, and resins) in the crude oil. Water and associated salts contained in the emulsion can interfere with the further processing of crude oil, especially its transportation, refining, and distillation.

Moreover, in a number of settings, the dispersion or mobilization of oily materials into a water phase is desired for cleaning, improved oil recovery, formulating or industrial processing purposes. Cleaning and degreasing activities are often aimed at dispersing oil based “soils” into water with the aid of surface active agents. Cleaning activities can include household and institutional (H&I) cleaning, commercial degreasing, and industrial cleaning such as oilfield applications. Oilfield cleaning activities include such operations as rig washing, wellbore cleaning, general purpose degreasing, sludge removal, and removal of wax, grease, oil, paraffin, resin, and asphaltenes from equipment, pipes, screens and tanks. In many industries, emulsion and dispersion type formulated products are manufactured with oils, waxes, polymers, and resins as the dispersed phase, for example wax emulsions, H&I cleaner products, and oilfield degreaser formulations. The emulsions of these products are preferably stable against separation during manufacture, transport, storage, and use.

Certain industrial processes such as oil recovery from a geologic deposit are complicated by the adhesion of oil to the rock surfaces and pores in the geologic matrix. Oil recovery under these circumstances is made more efficient by dispersion of the oil into a mobilized water phase. However, the dispersion process for these operations can be complicated by the insolubility, viscosity, or incompatibility of the oily substances with aqueous phases. Surfactants are known to reduce the surface tension of water and reduce the interfacial tension between oil and water phases, making the oils easier to disperse. While these conventional surfactants may be effective at emulsifying oily materials into water, the dispersion of oily materials can be performed inefficiently or incompletely. There remains a need in the art, therefore, for improved methods for mobilizing oil into water.

### SUMMARY

The present invention provides compositions comprising tunable polymeric surfactants and methods of use thereof for recovering oil.

In an embodiment, the invention provides a tunable polymeric surfactant or formulation thereof, for example, a suspension or solution in an aqueous vehicle. The surfactant is amphiphilic and has a plurality of hydrophobic binding sites and a plurality of hydrophilic binding sites. In preferred embodiments, the polymeric surfactant has a brush type configuration, a loop type configuration or comprises a backbone with a plurality of hydrophobic segments and a plurality of pendant hydrophilic polymeric side chains attached to the backbone.

In an embodiment, the invention provides a method of removing oil or an oil film from a surface. The method comprises the steps of: (a) providing a surfactant formulation of the invention; (b) contacting the oil or oil film with the surfactant formulation to attach a plurality of the surfactant's hydrophobic binding sites to the oil film; (c) flooding the surface with an aqueous solution, thereby lifting the surfactant and attached oil from the surface to form an aqueous/oil emulsion; and (d) collecting the aqueous/oil emulsion. In preferred embodiments, the method further comprises the step of altering the emulsion conditions to reduce the ability of the surfactant to stabilize the emulsion, thereby demulsifying the emulsion. The method can also include the step of separating the oil from the aqueous phase.

In an embodiment, the invention provides a formulation for enhanced oil recovery, comprising: a tunable amphiphilic polymeric material of the invention, and an aqueous flooding material, wherein the polymeric material increases the viscosity of the aqueous flooding material.

In an embodiment, the invention provides a method for enhanced oil recovery, comprising the steps of: (a) providing a surfactant formulation of the invention; (b) accessing a residual oil deposit in a rock reservoir formation; (c) delivering the formulation into the rock reservoir formation to mobilize the residual oil deposit; and (d) collecting the resulting oil/water emulsion. In preferred embodiments, the method further comprises the step of altering the emulsion conditions to reduce the ability of the surfactant to stabilize the emulsion, thereby demulsifying the emulsion. The method can also include the step of separating the oil from the aqueous phase.

In an embodiment, the invention provides a method for desludging an oil containment vessel, comprising the steps of: (a) providing surfactant formulation of the invention; (b) injecting the surfactant formulation into the sludge, thereby forming an oil-in-water emulsion comprising the heavy crude oil components of the sludge; and (c) removing the oil-in-water emulsion from the oil containment vessel, thereby desludging the oil containment vessel. In preferred embodiments, the method further comprises the step of altering the emulsion conditions to reduce the ability of the surfactant to stabilize the emulsion, thereby demulsifying the emulsion. Preferably, the oil-in-water emulsion is segregated in a separation vessel. The method can further comprise the step of altering the emulsion conditions to reduce the ability of the surfactant to stabilize the emulsion, thereby demulsifying the emulsion. The method can further comprise the step of separating the oil from the aqueous phase, for example, by producing an oil fluid stream and a water fluid stream.

In an embodiment, the invention provides a method for desludging an oil contaminated sediment, comprising the steps of: (a) providing a surfactant formulation of the invention; (b) injecting the surfactant formulation into the sediment, thereby forming an oil-in-water emulsion comprising the heavy crude oil components of the contaminated sediment; and (c) removing the oil-in-water emulsion from the oil contaminated sediment, thereby desludging the oil contaminated sediment. In preferred embodiments, the method further comprises the step of altering the emulsion conditions to reduce the ability of the surfactant to stabilize the emulsion, thereby demulsifying the emulsion. The method can also include the step of separating the oil from the aqueous phase.

### BRIEF DESCRIPTION OF THE FIGURE

The FIGURE is a graph showing the data for Example 7.

### DETAILED DESCRIPTION

An emulsion is a heterogeneous system comprised of two immiscible liquids, where one of the liquids is intimately dispersed in the other liquid in the form of droplets. The emulsion matrix is termed the external or continuous phase of the emulsion, and the phase comprised of the dispersed small droplets is called the internal or discontinuous phase. In a crude oil and water emulsion, oil sometimes forms the continuous phase and water is dispersed therein as fine, spherical droplets. Thus, a water-in-oil (w/o) emulsion is formed. The spherical droplets of water form as a result of the interfacial tension that pushes the water droplets to their minimum surface area, hence spheres. In other cases, an oil-in-water (o/w) emulsion is formed with water as the external phase and oil as the dispersed phase. An emulsion can be stabilized or destabilized by the presence of surface-active agents called emulsifiers or demulsifiers. As an example, an emulsifying agent can form interfacial films around the droplets in the dispersed phase to create a barrier that interferes with the coalescence of the emulsified droplets. If an emulsion is destabilized, the droplets tend to coalesce into larger sizes, causing the phases to separate by gravitational settling. Conversely, in a stable emulsion, the two components remain admixed.

Disclosed herein, in embodiments, are tunable surfactant technologies capable of reducing the surface tension of water and reducing the interfacial tension between oil and water phases. The surfactants employed in these systems and methods are polymeric in nature, yielding a material with a complex three-dimensional structure that has the ability to deploy itself at the interface of oil and water phases.

In embodiments, the tunable surfactants disclosed herein can produce a viscous solution in the bulk aqueous phase. This viscosity effect, even if it provides a modest increase (e.g. 10 cps) over the viscosity of water, can improve the sweep efficiency of an oil recovery solution upon injection into a petroleum reservoir. The viscosity of the aqueous sweep solution can create a resistance to flow, allowing the injected fluid to more effectively displace the targeted oil phase, causing the oil to flow towards a recovery well.

In embodiments, the tunable surfactants disclosed herein can self-assemble at an oil-water interface, with the hydrophobic part(s) of the surfactant being oriented towards the oil phase and the hydrophilic part(s) being oriented towards the external water phase. The polymeric nature of the tunable surfactants can allow multiple points of adsorption upon a surface or interface, thereby increasing the efficiency of adsorption when compared to a monomeric surfactant. The polymeric nature of the tunable surfactants can also allow the material to affect the microenvironment surrounding an encapsulated oil droplet. For example, polymer chains or entangled polymer networks extending into the water phase from the oil/water interface can create a viscous fluid in the aqueous layer immediately surrounding the oil. As the water phase flows past the encapsulated oil droplet, this viscous aqueous layer can cause a drag effect that pulls the encapsulated oil from an adhered surface.

In embodiments, the viscous layer around the encapsulated or emulsified oil phase can act as a protective colloid to prevent coalescence of emulsion droplets. The protective layer can enhance the stability of an emulsion during storage or during the shearing events of fluid transport. In other embodiments, a tunable surfactant as disclosed herein can be transported in an aqueous solution until contacting an oily material, which then changes the surfactant's behavior and impels it to encapsulate the oil phase.

As used herein, the term “tunable” or “switchable” refers to a surfactant that changes its chemical behavior in response to environmental stimuli. In embodiments, under a first set of conditions, the surfactant in an aqueous phase interacts with materials in an oily phase to create a stabilized dispersion or emulsion of such materials, and under a second set of conditions, the stabilized dispersion or emulsion can be destabilized or demulsified in a controlled manner. The surfactant can be designed such that the switchable behavior can be reversible or irreversible. In embodiments, conditions that can be varied to trigger the tunable or switchable behavior include conditions such as pH, temperature, ionic strength and the like, or the presence of a ‘breaker’ material, which inhibits the ability of the surfactant to stabilize the emulsion. Breaker materials can include ionic species with opposing charge to the surfactant, for example a cationic polymer or cationic multivalent metal salt can act as a breaker for an emulsion stabilized by anionic surfactant, while an anionic polymer can act as a breaker for an emulsion stabilized by cationic surfactant. Alternatively, breaker materials can be surfactant based compositions that change the hydrophilic-lipophilic balance (HLB) of the system to make the conditions more favorable to form o/w (high HLB) or w/o (low HLB) emulsions.

As an example, pH switchable surfactants can demonstrate switchable behavior based on pH, where the surfactant is capable of sustaining an emulsion at a higher pH, but loses its emulsification properties at a lower pH. In embodiments, pH switchable surfactants can comprise an ionizable group and a hydrophobic portion, or an ionizable portion and a hydrophilic and a hydrophobic portion. The ionizable group on the surfactant reacts to changes in pH that impact its emulsification properties. For example, with a decrease in pH, the ionizable group will be in the protonated form and the surfactant molecule can lose its solubility in water solution, thereby losing its emulsification properties. Conversely, if the pH increases, the ionizable group will be in the ionic form and the surfactant molecule will increase its solubility in water solution, thus being capable of sustaining emulsions of oil in water. This behavior is reversible because no functional groups are cleaved in the process.

As another example, temperature switchable surfactants can demonstrate switchable behavior based on changes in temperature, whereby they are able to stabilize emulsions at temperatures below their cloud points but lose their emulsification properties at temperatures above their cloud points. Temperature switchable surfactants can comprise a hydrophobic portion and a hydrophilic portion mainly containing, for example, ethoxylated or polyethoxylated groups. Other temperature switchable structures can include N-isopropylacrylamide units. Such surfactants will display solubility in water solutions at temperatures below the cloud point and will be able to emulsify oil in water. However, upon increasing the temperature over the cloud point, the surfactants will lose solubility in water solutions and will lose their emulsification properties. The behavior is reversible because no functional groups are cleaved in the process.

As another example, certain surfactants can demonstrate switchable behavior controlled by temperature and pH. Below a certain pH, the surfactant will have emulsification properties below certain temperature. However, over that pH, the temperature at which the surfactant has emulsification properties will increase. This provides two separate triggers that control the emulsification behavior of such surfactants.

Uses for the tunable surfactants disclosed herein can be based upon these types of properties. For example, in embodiments, the tunable surfactants can be used to clean oily materials from surfaces or solids, for example household and industrial cleaning, commercial degreasing, and cleaning of oilfield and similar specialized situations. In the oilfield, as a specific example, tanks, rigs, pipelines, tools and equipment can be cleaned with tunable surfactants as disclosed herein to remove adherent deposits of oily materials such as crude oils, drilling fluids, bitumen, asphaltenes, greases, lubricants, waxes, paraffins, and the like. Similarly, the tunable surfactants as disclosed herein can remove oily materials from contaminated sediments or from rock formations. In certain embodiments, the tunable surfactants can be used, for example, to displace oil from a petroleum reservoir for enhanced oil recovery. In certain embodiments, the tunable surfactants as disclosed herein can be used to formulate stabilized emulsions or dispersions of oil phases in water-continuous systems. Examples of this use include emulsions of hydrocarbons, terpenes, waxes and the like.

By taking advantage of the properties of the tunable surfactants as disclosed herein, a number of problems in industrial processing can be advantageously addressed, as can be seen in the following examples.

1. Sludge Treatment

Crude oil is typically produced in association with connate water. In the field, the well outflow stream is first separated into its three components: natural gas, crude oil and produced water. The produced water and crude oil, however, can form a stable emulsion that can interfere with ready separation of these two components. Furthermore, water can also be introduced into an oil-bearing formation to apply pressure to the oil within the formation to keep it flowing. Oil that is recovered under these circumstances also contains a water fraction, typically dispersed as a stable emulsion. This stabilized layer of water in oil, known as the “rag layer,” actually includes multiple phases, such as solid-in-oil dispersions, water-in-oil emulsions, and oil-in-water-in-oil emulsions.

Asphaltenes are high-molecular weight, complex aromatic ring structures that can also contain oxygen, nitrogen, sulfur or heavy metals. As polar molecules, they tend to bond to charged surfaces, especially clays, leading to formation plugging and oil wetting of formations. Asphaltenes tend to be colloidally dispersed in crude oils, stabilized by oil resins. Asphaltenes, paraffinic waxes, resins and other high-molecular-weight components of heavy crude exist in a polydisperse balance within the heavy crude fluid. A change in the temperature, pressure or composition can destabilize the polydisperse crude oil. Then the heavy and/or polar fractions can separate from the oil mixture into steric colloids, aggregates, micelles, a separate liquid phase, and/or into a solid precipitate. The asphaltene micelles can be destabilized during well treatments, e.g., acidizing or condensate treatments, leading to asphaltene precipitation. Asphaltene precipitation causes problems all along the crude oil recovery process. Asphaltene precipitation becomes increasingly problematic when crude oil is processed, transported, or stored at cooler temperatures, because the heavier components of crude oil (e.g., asphaltenes and resins) that remain dissolved in the heavy crude under high temperatures and pressures are no longer supported in that state as the conditions change. When the heavy crude oil cools to ambient atmospheric temperatures, these components can precipitate out of the crude oil itself and lodge at the bottom of a storage vessel or tank to form a viscous, tarry sludge. These components also become available as emulsifying agents to sustain the water-in-oil emulsions formed as part of the rag layer. The rag layer has a higher density than light crude, so that it tends to sink to the bottom of storage vessels along with the heavy oil components and associated clay/mineral solids, contributing to the buildup of oil sludge, a thick waste material formed from the various deposits sedimenting out from a crude oil mixture.

Sludge forms when heavier components of crude oil separate from the liquid hydrocarbon fractions by gravity and sink to the bottom of the vessel. Components of the sludge can include usable hydrocarbons along with the aforesaid entrained water as a water-in-oil emulsion, along with a multitude or organic and inorganic components and contaminants. As the heavier elements in the stored oil continue to migrate to the vessel bottom, the sludge becomes increasingly viscous over time. Any given storage vessel can thus contain a significant amount of sludge, which can diminish storage space for useful crude oil and which can otherwise reduce the efficiency of storage tank operation. Sludge may also require removal if the storage vessel is to be maintained, repaired or inspected. In embodiments, the sludge can contain finely divided or granular mineral solids, in amounts up to 80% by weight. These solids can be oil-wetted by hydrocarbons, asphaltenes, and the like.

In the course of activities related to onshore production, offshore production, transportation, refining, and use of oil, spills and other undesirable releases of hydrocarbons can occur. Contaminated sediments are formed when oily materials contact sand, soil, rocks, beaches, and the like. In some cases, the spills are from long term gradual releases at industrial sites, and in other cases the spills can be from catastrophic accidental discharges. In either event, the contaminated soils will require remediation to prevent further environmental damage. The contaminated soil can be in the form of oil-soaked sediments, or water/oil mixtures with solids, including emulsions. In other embodiments, oil-soaked sediments can exist as a naturally occurring deposit such as oil sands or oil shales. These sediments contain oils, heavy oils, or bitumen that has commercial value. Since all of these contaminated soils have features in common with tank bottoms sludges, the same treatment processes could be applied to both cases.

Disclosed herein are tunable surfactants that can emulsify sludge; upon a change in conditions, the emulsion can be broken to separate the components. This approach can also be applied to the treatment of oil-contaminated sediments. In embodiments, the surfactant can be injected as an aqueous solution into an oil storage vessel to emulsify the heavy oil sludge into the water phase with minimal agitation. Establishing water as the continuous phase of the emulsion for the sludge can decrease the sludge viscosity so that it can be pumped out of the storage vessel into an alternate containment system. For example, the sludge-in-water emulsion can be directed to a distinct separation vessel, where the emulsion can then be broken, yielding a phase-separate two-component system comprised of crude oil fractions suitable for further refining and recovered water suitable for reuse in similar or other projects.

In embodiments, several steps will be required for the surfactant system. First, the surfactant will be injected into the heavy oil sludge (including the rag layer), so that the surfactant can destabilize the heavy oil-water interface to invert the emulsion into the water phase. In this initial phase, an amphiphilic, water-soluble polymer can be used that is effective at low concentrations. After this is accomplished, the resulting water emulsion can be removed from the subject vessel and relocated, for example to a separation vessel. This may take place as a separate step after the first step has been completed. In other embodiments, however, this can take place during the first step. For example, the water emulsion can be siphoned off as it is formed. As a final step, the water emulsion containing the stabilized oil droplets can be demulsified. A change in the conditions of the water emulsion can change the conformation of the surfactant, so that it breaks into an oil-soluble component and a water-soluble component. The oil-soluble component thus demulsifies the heavy oil droplets, while the water-soluble component remains in the water phase. Surfactant molecules can be designed so that the water-soluble byproduct is non-toxic and environmentally safe. The emulsification and/or separation processes are optionally carried out at temperatures above ambient, to facilitate flow and emulsification or to cause switching of the surfactant properties.

In embodiments, a surfactant in accordance with these formulations and methods can be formulated as a polymer that can emulsify the heavy crudes, but can decompose into one or more oligomers capable of effecting demulsification. Oligomers suitable for demulsifying can include polyethylene oxide/polypropylene oxide copolymers, cellulose esters, polyethylene/ethylene oxide copolymers, ethoxylated nonylphenols, and the like. In embodiments, the polymeric surfactant used for sludge treatment can be of the general polymeric arrangement of -[-hydrophobe-]ₓ-[-hydrophile-]_{y}-. In other embodiments, a random linear copolymer can act as the emulsifying agent. Such a copolymer can contain regions of ionic charge, such as a quaternary amine or sulfonate, that would be resistant to the high-salt environment in the sludge. To create the surfactant effect, the copolymer can optionally further contain nonionic regions having hydrophobicity, such as polycarbonate, polystyrene or styrene maleic anhydride. In the copolymer, a demulsifying oligomer (as set forth above) can be covalently attached to the nonionic hydrophobic regions.

As a first step for using these formulations, the sludge can be emulsified using the surfactants to form an oil-in-water emulsion. The emulsion can then be pumped from the subject tank or other vessel to a suitable separation vessel. Heat can be optionally added. In the separation vessel, the pH can optionally be altered so that the covalent linkage holding the demulsifying moieties in place is broken. If the covalent bond is a weak one (e.g., an ester bond), it may be altered by adding heat only. For other covalent linkages (e.g., ethers and amides), alkali may need to be added to the emulsion to facilitate bond cleavage. With the release of the demulsifying agent from its attachment to the polymer, phase separation of oil and water occur. Water and oil can then be directed for further processing as separate fluid streams. In some cases, the oily fraction of the sludge can be advantageously mobilized or displaced from the adherent surfaces by the tunable polymeric surfactants, without the evident formation of an emulsion. In this displacement process, the oil is observed to detach and segregate from the solids as evidenced by visible oil droplets or layers.

2. Wellbore Cleanout

Following drilling into an oil or gas reservoir, the wellbore annulus must be cleaned to remove drilling fluids, gelled drilling fluid, residual additives from drilling fluids, and the like, especially when oil-based or synthetic drilling fluids are used. Such drilling fluids can include as their base material any of a number of natural or synthetic oils, including petroleum fractions, synthetic compounds, blends of natural and synthetic oils, along with a variety of performance-enhancing additives. One cleaning process can take place before the casing and cementing operations are done, and another cleaning process is done after the casing is installed. The casing must be cleaned to a water-wet condition with no oil sheen.

Oil-based and synthetic drilling fluids are especially difficult to remove from the surfaces they contact. These oil-based fluids can form invert emulsions upon contact with water, where the continuous phase is predominantly organic, and the discontinuous phase is aqueous. As an example, an oil-based drilling fluid (an “oil-based mud” or OBM) can be made of one or more natural or synthetic oils, and can emulsify up to 50% by fluid volume of the aqueous component. As an example, water can be dispersed in the oil as tiny droplets, often less than a micron in diameter. The stability of the emulsion can be influenced by one or more additives in the fluid. This emulsion will tenaciously coat any surface that it contacts, leading to oil wetting of borehole surfaces, casing surfaces, and the surfaces of other equipment that it contacts.

Disclosed herein are polymeric surfactants of brush and loop types to attach to oily deposits and create viscous domain at the surface to enable lifting off of oily matter. In embodiments, these surfactants can be used in formulations for cleaning wellbores to remove films left behind from the use of oil-based drilling fluids, and at the same time leave the wellbore surface in a hydrophilic state.

In embodiments, the water-based polymeric surfactants disclosed herein can be designed to have high oil affinity at multiple contact points, so that it attaches securely to the oily component of, for example, an OBM-derived oil film. At the same time, the polymeric surfactant can have multiple hydrophilic regions that can attract aqueous fluids to wash away or break up the oil. The polymeric surfactant will be sized so that it embeds itself within the oil film at a number of contact points, so that it is well-affixed to the oily target; the surfactant will also have numerous hydrophilic contact points. This design will render the surfactant more powerful than conventional small-molecule surfactants in lifting the oil residue from target surfaces because it has more “hooks” into the oil and because it has more hydrophilic “handles” to attach to aqueous solutions used to flush away the oil or to disperse it. As an additional benefit, removing the oil layer using this surfactant can also remove particulate matter suspended in such oil.

In embodiments, the polymeric surfactant can have a “brush” design. Such a surfactant can have a polymeric backbone with multiple hydrophobic segments that provide attaching points to the oil, the “hooks.” Pendant from the backbone can be a plurality of hydrophilic polymeric side-branches like bristles attached to the polymeric backbone. This surfactant can encapsulate the oil and oil-wetted solids via the hydrophobic backbone. The hydrophilic segments then act as “handles,” extending into an aqueous solution and allowing that fluid to associate with the polymeric complex, thereby helping to emulsify, disperse and dislodge the oily film. In other embodiments, the polymeric surfactant can have a “loop” design. Such a surfactant can be a block copolymer with certain segments having high oil affinity and other segments being hydrophilic. The surfactant's hydrophobic segments can be drawn to the oily layer to encapsulate it. Various configurations of the hydrophilic segments can be designed so that their actions can serve to emulsify, disperse and dislodge the oily film, for example by forming loops around the encapsulated oily areas. In embodiments, polymeric surfactants can be formed comprising combinations of these or similar features that would permit the simultaneous oil attachment and aqueous attachment across a multitude of contact points for each. Because the polymeric surfactant is delivered as a water-based formulation, its use can leave the wellbore surfaces in a water-wet state.

Advantageously, surfactants having the aforesaid properties can be designed to be compatible with other materials used in the wellbore cleaning process or the oil production process, for example brines and/or sea water. In embodiments, polymeric surfactants can be designed wherein the hydrophobic “hooks” of the polymer have particular affinity for the target oil, for example an oily residue left behind by a specific OBM. In embodiments, the molecular weight of the surfactant can be designed so that its viscosity is sufficient to exert a pulling force on the target oil adherent to the wellbore surface, but so that it does not interfere with the turbulent flow of cleaning materials often used as part of the wellbore cleaning process. In embodiments, formulations comprising the polymeric surfactants can be prepared that include other useful additives, such as corrosion inhibitors, clay hydration suppressants, solvents, cosolvents, hydrotropes, dispersants, sorbents, and the like. In embodiments, formulations comprising the polymeric surfactants can be used in combination with other cleaning materials, either sequentially or as combination products.

In embodiments, useful polymers for the surfactant backbone can include such materials as poly(maleic anhydride-alt-1-octadecene), poly(octadecyl methacrylate-co-acrylic acid), poly(octadecyl methacrylate-co-methacrylic acid), polypropylene-graft-maleic anhydride, poly(isobutylene-co-maleic anhydride), poly(ethylene-alt-maleic anhydride), poly(ethylene-co-glycidyl methacrylate), and the like. In embodiments, useful polymers for the pendant hydrophilic components can include poly(ethylene glycol-ran-propylene glycol)monobutyl ether (with a high ratio polyethylene glycol/polypropylene glycol ratio), poly(ethylene glycol)monobutyl ether, JEFFAMINE® monoamine (M series) such as M-1000 (Hunstman), and the like. In embodiments, block copolymers in accordance with these formulations and methods can include poly(propylene glycol)diglycidyl ether—block-JEFFAMINE® ED-600, poly(propylene glycol)bis(2-aminopropyl ether)—block-poly(ethylene glycol), and the like.

In one embodiment, a polymeric surfactant having a “brush” type configuration can be prepared, for example, by the reaction of poly(maleic anhydride-alt-1-octadecene) with Poly(ethylene glycol-ran-propylene glycol)monobutyl ether (having a high ratio of PEG/PPG). In another embodiment, a “brush” type polymeric surfactant can be prepared, for example, by the reaction of Poly(maleic anhydride-alt-1-octadecene) with Poly(ethylene glycol)monobutyl ether. In another embodiment, a “brush” type polymeric surfactant can be prepared, for example, by the reaction of Poly(maleic anhydride-alt-1-octadecene) with JEFFAMINE® monoamine (M-1000). In another embodiment, a “brush” type polymeric surfactant can be prepared, for example, by the reaction of Poly(octadecyl methacrylate-co-acrylic acid) with Poly(ethylene glycol)monobutyl ether. In another embodiment, a “brush” type polymeric surfactant can be prepared, for example, by the reaction of polypropylene-graft-maleic anhydride with Poly(ethylene glycol-ran-propylene glycol)monobutyl ether (having a high ratio of PEG/PPG). In another embodiment, a “brush” type polymeric surfactant can be prepared, for example, by the reaction of Poly(ethylene-co-glycidyl methacrylate) with JEFFAMINE® monoamine (M-1000). In another embodiment, a polymeric surfactant having a “loop” type configuration can be prepared, for example, by the reaction of poly(propylene glycol)diglycidyl ether with JEFFAMINE® ED-600. In another embodiment, a “loop” type polymeric surfactant can be prepared, for example, by the reaction of polypropylene glycol)bis(2-aminopropyl ether) with polyethylene glycol diglycidyl ether.

3. Enhanced Oil Recovery

Retrieving the normally immobile residual oil residing in the oil field after primary and secondary recovery is referred to herein as “tertiary recovery” or “enhanced oil recovery” (EOR). Tertiary recovery or enhanced oil recovery (EOR) methods are used to improve production of a subterranean oil reserve. A majority of these reservoirs are composed of high porosity, low permeability carbonate, as has been described, for example, in Wu, Yongfu et al. “An Experimental Study of Wetting Behavior and Surfactant EOR in Carbonates with Model Compounds.” Society of Petroleum Engineers, March, 26-34 (2008). The low permeability of the reservoir substrate is caused in part by oil trapped in the porous media, which can be formed by the combined effects of high viscosity and high interfacial tension (IFT), into oil globules that are not easily deformed. While conventional oil having a viscosity between 1-10 cps can easily be displaced and pumped out of the reservoir during primary and secondary extraction, heavy oil (viscosity of 20-1,000,000 cps) can remain trapped in the formation. Increasing oil demand has made enhanced oil recovery a more attractive means of oil production.

Disclosed herein are switchable polymeric surfactants that (1) increase the viscosity of the flooding solution and then (2) self-assemble on the surface of oil and change to a surfactant behavior to aid emulsification. In embodiments, these surfactants can be used in EOR to improve the mobility of oil while making the rock reservoir water-wet to improve its permeability and allow for the recovery of oil at an increased rate. Disclosed herein are EOR systems and methods which involve using novel thickening polymers that can self-assemble at the oil surface and act as an efficient emulsifier. In embodiments, aqueous fluids are designed that will increase sweep efficiency and percent recovery for EOR.

It is understood that the efficiency of a displacing fluid can be defined by the mobility ratio as well as the capillary number. The mobility ratio is indicated by Equation 1.

$$M = \frac{k / μ ( displacingfluid )}{k / μ ( displacedfluid )} \qquad Equation 1$$

In Equation 1, k is the permeability of the media and μ is the viscosity of the fluid. The mobility ratio indicates the sweeping efficiency of a displacing fluid. A mobility ratio <1 can mobilize oil while >1 cannot. The capillary number is indicated by Equation 2.

$$Ca = V \frac{μ}{γ} \qquad Equation 2$$

In Equation 2, V is the characteristic velocity, μ is the viscosity of the displacing fluid and γ is the IFT. The capillary number is a dimensionless number that characterizes the relationship of viscosity and IFT of two immiscible fluids. Low capillary number indicates capillary forces will determine the flow through the rock reservoir. The percent oil recovery increases as a function of the capillary number of a displacing fluid. Fluids such as water that have a high mobility ratio and low capillary number will take the least tortuous path through the formation and therefore are poor displacing fluids.

It is understood that a polymeric surfactant can give a low mobility ratio with a high capillary number as a single component system even in low concentrations. Although in theory, either a low mobility ratio or high capillary number can give 100% oil recovery, this is not observed in practice. In embodiments, these systems and methods can provide for a cost effective and efficient method for EOR that improves both the mobility ratio and capillary number of the displacing fluid. In embodiments, an amphiphilic polymer can be used to act as a thickener in the displacing aqueous phase which can self-assemble onto the surface of oil and act as a surfactant in the oil phase.

EOR processes must be robust enough to survive the subterranean environments that typically see temperatures in excess of 100° C. while salinity and dissolved solids can vary greatly. In embodiments, polymers are selected that can withstand high temperatures without degrading. For example, hydrophilic groups can shield the polymer from changes in water chemistry including multivalent cations. Or, for example, the polymer can be diluted and delivered in a brine solution which can significantly reduce cost. In embodiments, the self-stabilizing polymeric surfactant can serve to hinder precipitation unless in the presence of a strong hydrophobe. In embodiments, for example, the stability of the polymer surfactant is only broken down in the presence of hydrophobic compounds such as oil. At this point, a selected polymer would cease to behave as a polymer slug and would become more like a surfactant. It is understood that the presence of a hydrophobe would destabilize the selected polymer, and it could undergo a conformation change to a more stable structure that could effectively emulsify oil. A hydrophobic component of the selected polymer could penetrate the oil-water interface and effectively reduce the IFT. The polymer could also have the effect of slightly reducing the viscosity of the oil in the surrounding area.

Using the surfactant formulations as disclosed herein, stimuli-responsive surfactant templates can be produced in polymeric form for EOR applications. In embodiments, a polymer could emulsify or demulsify due to a certain stimulus such as pH or temperature. Demulsification, for example, could be used to improve oil reclamation in an ex-situ process. In embodiments, polymeric agents such as polyimide-amine salts of styrene-maleic anhydride (SMA) copolymers could be used as surfactants in accordance with this disclosure. In one embodiment, a SMA copolymer having pendant tertiary amine groups containing a salt-forming tertiary nitrogen atom neutralized to the extent of at least about 75 percent with monocarboxylic acids, having for example an aliphatic chain of at least about 8 carbon atoms, could be used. In embodiments, the polyimide-amine salts useful for EOR can also contain mixed imides, resulting, for example from the reaction of dialkylaminoalkylamines and monoalkyl amines, or mixed imide-amides resulting from the reaction of dialkylaminoalkylamines and dialkylamines.

In embodiments, salts can be prepared by converting the anhydride rings of styrene-maleic anhydride copolymers to polyimides containing pendant tertiary amine groups. These pendant tertiary amine groups can be neutralized with monocarboxylic acids to form salts that have useful properties for EOR. Mixed imide forms of these salts can be obtained by reacting primary alkylamines with a minor portion of the anhydride groups of the styrene-maleic anhydride copolymer. Similarly, mixed imide-amide forms of the salts can be obtained by reacting a minor portion of the copolymer anhydride groups with secondary dialkylamines. In embodiments, useful polymers for this disclosure could be formed from polyimide-amine acid salts of styrene-maleic anhydride copolymers containing pendant tertiary amine groups that are neutralized to the extent of at least about 75 percent with sufficient monocarboxylic acid having an aliphatic carbon-to-carbon chain of at least about 8 carbon atoms, preferably as a terminal group. In embodiments, a styrene-maleic anhydride copolymer can be imidized to the extent of at least about 65 percent up to about 100 percent of its anhydride groups, and neutralized with a dialkylaminoalkylamine to the extent of about 75 percent to 100 percent, with the long chain monocarboxylic acid. The styrene-maleic anhydride copolymer polyimide-amine acid salts can also contain imide groups or amide groups up to the extent of about 35 percent of its anhydride groups by reaction with a primary or secondary alkylamine, for instance, of about 8 to 30 carbon atoms. In embodiments, the ratio of styrene to maleic anhydride in the styrene-maleic anhydride copolymer of this invention can be in the range of about 0.1:1 to 5:1, preferably about 0.5:1 to 2:1, and most preferably about 1:1. In embodiments, the styrene-maleic anhydride copolymer molecular weight can vary from about 400 to 5,000, preferably from about 1,000 to 5,000, and often is in the range of about 1,400 to 2,000. In embodiments, long hydrophilic chains can be attached to the copolymer backbone. Polymers such as those disclosed herein can be used to formulate surfactants that have multipoint interaction with aromatic heavy oil, thus yielding utility in EOR. In embodiments, the polymers can be modified, for example by adding hydrophilic chains (e.g., polypropylene oxide/polyethylene oxide polymeric chains) to promote pulling emulsified oil drops into water.

### EXAMPLES

### Example 1

### Tunable Surfactant Additive

A tunable surfactant additive can be synthesized in a batch process. To form the additive, stoichiometric relative quantities of the two starting materials can be dissolved in a known organic solvent, acetone. The main backbone of the additive can consist of a random copolymer while the additional component can consist of an end-functionalized known demulsifier. The two reaction components can be refluxed in acetone for 24 hours, after which time, the desired product can be recovered using known means of synthetic work-up. The recovered product or additive can now be dissolved into aqueous buffer solution at 1.0% by weight. The additive solution formed thereby can be agitated to ensure thorough mixing.

As a next step, the additive solution can be added to a jar containing heavy oil tank bottoms sludge. The sludge can consist of heavy oil rag layer, trapped oil, water and solids at a ratio of 30:50:15:5 percent by weight, respectively. The additive solution can be mixed with the sludge at a 50:50 volume ratio. Following adequate emulsification, as indicated by the formation of suspended oil droplets in the water phase, the mixture would be tested for specific properties, such as oil composition and kinematic viscosity. These tests would give indication into: a) the relative quantity of recoverable oil from the sludge, and b) the emulsions ability to be pumped. The emulsion can also be tested for stability on a time basis by leaving the jar to set for 24 hours. After that amount of time, the emulsion would be broken by adjusting the solution pH to approximately 10. The emulsion would be heated to 40 degrees Celsius to help facilitate the phase separation of the oil and water layers. The oil layer would be decanted from the top of the jar and measured for water and solids content. The water layer and any remaining sludge component can also be separated and tested for composition.

### Example 2

### Cleaning Contaminated Soil

A preparation simulating a contaminated soil was prepared by adding 20 gms of sand (white quartz, −50+70 mesh) from Aldrich, and 2 grams of crude oil (Hybrane-Bonja crude-oil, from DSM) to a 100 ml beaker. The mixture was manually stirred with a spatula until the sand appeared homogenously coated with the crude oil (dark brown solid). To this mixture was added 25 grams of a 1% solution of 2-(1-octadecenyl)succinic acid 4-polyethylene glycol ester (Mw Polyethylene glycol=1000), followed by the addition of 25 grams of a 1% solution of Nonedecyl succinic acid 4-benzyl ester. The mixture was vigorously stirred with a spatula for 1 minute. Upon standing for 5 minutes the sample appeared as: a clean layer of sand at the bottom of the beaker, a brown oily layer on the surface of the liquid, corresponding to the crude oil, and a clear aqueous phase in the middle. In addition to the aforesaid experimental protocol, a control sample was also tested. To prepare the control preparation simulating the contaminated soil, a mixture of sand and crude oil was prepared as described above. 50 grams of deionized water was added and, the mixture was vigorously stirred for 1 minute. Upon standing for 5 minutes the sample appeared as a dark brown solid (sand-crude oil) at the bottom of the beaker and a clear liquid overlying it. No oily layer was evident on the surface of the water.

### Example 3

### Synthesis of Polymeric Surfactant

A reactor was charged with 5 g of JEFFAMINE® M-1000 with MW=1,000 (HUNTSMAN, Austin, Tex. 78752, USA) dissolved in 10 g of tetrahydrofuran and 2.5 g of Chevron PA-18LV (The Woodlands, Tex. 77380) dissolved in 7 ml of tetrahydrofuran. The mixture was stirred for 3 hours under reflux and under nitrogen. Then the solvent was stripped off under vacuum and the product used without any further purification. The reaction was monitored by infrared, showing the disappearance of the anhydride peaks at 1859 and 1773 cm⁻¹. Other properties of the product that were identified include:
Solubility in water at 25° C.: ˜1%
Cloud point (1% aqueous): >100° C.

### Example 4

### Synthesis of Polymeric Surfactant

In this example, a “brush” type polymeric surfactant was synthesized, suitable for applications such as wellbore cleanout. A reactor was charged with 10 g (10 mmol) of JEFFAMINE® M-1000 (Hunstman) and 10 ml of tetrahydrofuran. The mixture was stirred with a magnetic bar until all the product dissolved. In a separate container it was dissolved 3.5 g of Chevron PA-18LV which is a poly(maleic anhydride-alt-1-octadecene), (MW˜20-25,000, available from Chevron) in 10 ml of tetrahydrofuran. Once all the product dissolved, it was added to the JEFFAMINE® mixture dropwise. The mixture was allowed to reflux for 3 hours. Next the solvent was evaporated in the rotary evaporator. The product was characterized by infrared, which showed the disappearance of the anhydride peaks at 1855 and 1781 cm⁻¹. The surfactant showed a solubility in water higher than 10 wt %; the cloud point of a 1 wt % solution was higher than 100° C. The resulting polymeric surfactant was further characterized by measuring its interfacial tension against different solvents. The interfacial tensions of a 1 wt % aqueous solution at room temperature were: 45.13 mN/m for air, 5.78 mN/m for toluene, 10.20 mN/m for Isopar M and 7.86 mN/m for crude oil (API=37.4).

### Example 5

### Synthesis of Polymeric Surfactant

In this example, a “loop” type surfactant was synthesized, suitable for applications such as wellbore cleanout. A reactor was charged with 5 g (2.5 mmol) of JEFFAMINE® ED-2003 (Hunstman) and the temperature increased to 60° C. via a silicone oil bath. Over 30 minutes 1.6 g of polypropylene glycol diglycidyl ether (Mn˜640) (Aldrich) was added dropwise. Once the addition was completed, the temperature was increased to 100° C. and the reaction allowed to continue for 30 more minutes. The resulting material was used without further purification. The surfactant showed a solubility in water higher than 10 wt %. The cloud point of a 1 wt % solution was 40-42° C. The resulting polymeric surfactant was further characterized by measuring the interfacial tension against different solvents. The interfacial tensions of a 1 wt % aqueous solution at room temperature were: 38.17 mN/m for air, 2.80 mN/m for toluene, 5.99 mN/m for Isopar M and 2.95 mN/m for crude oil (API=37.4).

### Example 6

### Synthesis of Polymeric Surfactant

This example describes the synthesis of a polymeric surfactant optimized for EOR applications. A reactor was charged with 2.5 g of dimethylaminopropyl amine (Aldrich) dissolved in a mixture of 5 ml of tetrahydrofuran and 20 ml of dimethylformamide (Aldrich). A solution of 8.53 g of Entel 2608 (Styrene Maleic Anhydride MW 80,000) supplied by T-Global Specialty Chemicals (West Chester, Pa. 19382) in 20 ml of tetrahydrofuran was added dropwise. The mixture was allowed to react at 40° C. for 4 hours. The resulting product was purified by precipitating over 250 ml of methanol (Aldrich) and decanting the liquid. Next the sample was dried under vacuum at 60° C. until constant weight. The product was then placed in a vacuum oven at 150° C. for 3 hours in order to obtain the imide. The presence of the imide was confirmed by infrared spectroscopy. The infrared spectra displayed the typical imide peaks around 1780 and 1720 cm⁻¹. The solubility of the sample was also tested, showing that the polymer dissolved in acidic water but not in basic water. This was another indication that the imide product with a pendant tertiary amine has been synthesized.

### Example 7

### Viscosity of Polymeric Surfactant

In this Example, the polymeric surfactant synthesized in Example 3 was tested to demonstrate its viscosity and shear thinning characteristics. A 1% solution of the surfactant synthesized in Example 3 was prepared by dissolving 0.34 g surfactant in 34 g of deionized water. The viscosity of the 1% solution was measured using a Brookfield DV-III viscometer at 25° C. at various rotation rates of the spindle. The data were plotted on Graph 1 (The FIGURE). The results indicated that the surfactant has increased viscosity with respect to water even at a 1% concentration. The plot also shows how the viscosity decreases with increased shear rate (expressed as higher spindle rotation rate in rpm); this indicates that the surfactant solution has pseudoplastic behavior, and in particular demonstrates a shear thinning effect. The shear thinning behavior observed for the surfactant solution is also reversible.

### Example 8

### Emulsion Capability of a Polymeric Surfactant

In this Example, the polymeric surfactant synthesized in Example 3 was tested for its ability to emulsify d-limonene, to demonstrate its suitability for use in a degreaser formulation comprising a material like d-limonene. A 0.1% solution of the surfactant synthesized in Example 3 was prepared by dissolving 0.01 g in 10 g of deionized water. To this solution was added 0.5 g of d-limonene. The mixture was emulsified by using a high shear mixer (PRO 200, Oxford, Conn.) for 5 minutes (power setting of the shear mixer 1 out of 5). The resulting milky solution was allowed to stand and its appearance recorded over time. The emulsion remained stable for several hours and no separation of phases was apparent.

### Example 9

### Switchable Behavior of the Polymeric Surfactant

An emulsion of a medium crude oil (API=26°) was prepared by mixing 2 g of a 0.1 wt % solution of the surfactant from Example 3 with 1 g of the medium crude oil. A drop of sodium hydroxide (1M) was also added. The mixture was then shaken manually for 10 seconds. The result was a light brown emulsion stable over time.

The switchability of the surfactant was tested as follows. To half of the above emulsion was added 1 drop of hydrochloric acid (1M) and, in addition, the sample was heated at 80° C. for a few seconds. Immediately the emulsion separated in 2 phases, with the water phase situated at the bottom of the vial and the crude oil phase at the top. As a control the other half of the emulsion was monitored over time but no separation of the emulsion was evident.

### Example 10

### Cleaning Capability of the Polymeric Surfactant

The cleaning capability of polymeric surfactant was tested by simulating a wellbore casing coated with the synthetic-based drilling muds. The testing sample consisted in a ½″ Sq Mild Steel Coupons from Speedy Metals (New Berlin, Wis.) coated with an oil used for formulating synthetic-based muds. The oil is a C16-C18 Isomerized Olefin Base Oil from Chevron. Next the oil-coated coupon was immersed in a beaker containing approximately 20 ml of a 1% surfactant from Example 3. After mixing gently for a few minutes, drops of oil were visible at the surface of the water and the metal coupon displayed an oil-free surface.

While this invention has been particularly shown and described with references to preferred embodiments thereof, it will be understood by those skilled in the art that various changes in form and details may be made therein without departing from the scope of the invention encompassed by the appended claims.

1. A tunable surfactant formulation, comprising:
an amphiphilic polymeric surfactant having a plurality of hydrophobic binding sites and a plurality of hydrophilic binding sites,
wherein said polymeric surfactant has:
(a) a brush type configuration;
(b) a loop type configuration; or
(c) comprises a backbone with a plurality of hydrophobic segments and a plurality of pendant hydrophilic polymeric side chains attached to the backbone; and
an aqueous vehicle in which the surfactant is suspended or dissolved.

2. The surfactant formulation of claim 1, wherein the polymeric surfactant has a “brush” type configuration.

3. The surfactant formulation of claim 1, wherein the polymeric surfactant has a “loop” type configuration.

4. The surfactant formulation of claim 1, wherein the polymeric surfactant comprises a backbone with a plurality of hydrophobic segments and a plurality of pendant hydrophilic polymeric side chains attached to the backbone.

5. The surfactant formulation of claim 1, wherein the polymeric surfactant is a block copolymer comprising one or more hydrophilic segments and one or more hydrophobic segments.

6. The surfactant of claim 4, wherein the backbone comprises poly(maleic anhydride-alt-1-octadecene), poly(octadecyl methacrylate-co-acrylic acid), poly(octadecyl methacrylate-co-methacrylic acid), polypropylene-graft-maleic anhydride, poly(isobutylene-co-maleic anhydride), poly(ethylene-alt-maleic anhydride), or poly(ethylene-co-glycidyl methacrylate).

7. The surfactant of claim 4, wherein the pendant hydrophilic side chains are selected from the group consisting of pendant hydrophilic components can include poly(ethylene glycol-ran-propylene glycol)monobutyl ether (with a high ratio polyethylene glycol/polypropylene glycol ratio), poly(ethylene glycol)monobutyl ether, JEFFAMINE® monoamine (M series), and a combination of any of thereof.

8. The surfactant of claim 5, wherein the block copolymer is selected from the group consisting of poly(propylene glycol)diglycidyl ether—block-JEFFAMINE® ED-600, and poly(propylene glycol)bis(2-aminopropyl ether)—block-poly(ethylene glycol).

9. A method of removing an oil film from a surface, comprising:
(a) providing a surfactant formulation in accordance with claim 1;
(b) contacting the oil film with the surfactant formulation to attach a plurality of the surfactant's hydrophobic binding sites to the oil film;
(c) flooding the surface with an aqueous solution, thereby lifting the surfactant and attached oil film from the surface to form an aqueous/oil emulsion; and
(d) collecting the aqueous/oil emulsion.

10. The method of claim 9, further comprising the step of altering the emulsion conditions to reduce the ability of the surfactant to stabilize the emulsion, thereby demulsifying the emulsion.

11. A formulation for enhanced oil recovery, comprising:
a tunable amphiphilic polymeric material; and
an aqueous flooding material, wherein the polymeric material increases the viscosity of the aqueous flooding material.

12. A method for enhanced oil recovery, comprising:
(a) providing a formulation for enhanced oil recovery according to claim 11;
(b) accessing a residual oil deposit in a rock reservoir formation;
(c) delivering the formulation into the rock reservoir formation to mobilize the residual oil deposit; and
(d) collecting the resulting oil/water emulsion.

13. The method of claim 12, further comprising the steps of:
(e) altering the emulsion conditions to reduce the ability of the surfactant to stabilize the emulsion, thereby demulsifying the emulsion; and
(f) separating the oil from the water.

14. The system of claim 10, wherein the polymeric material is a polyimide-amine salt of a styrene-maleic anhydride (SMA) copolymer.

15. The system of claim 10, wherein the polymeric material comprises hydrophilic chains.

16. The system of claim 15, wherein the hydrophilic chains are selected from the group consisting of polypropylene oxide chains, polyethylene oxide polymeric chains and combinations thereof.

17. A method for desludging an oil containment vessel, comprising:
(a) providing an aqueous surfactant solution comprising a tunable amphiphilic surfactant capable of emulsifying heavy crude oil components that have settled in a sludge in the oil containment vessel;
(b) injecting the aqueous surfactant mixture into the sludge, thereby forming an oil-in-water emulsion comprising the heavy crude oil components of the sludge; and
(c) removing the oil-in-water emulsion from the oil containment vessel, thereby desludging the oil containment vessel.

18. The method of claim 17, further comprising:
(d) segregating the oil-in-water emulsion in a separation vessel.

19. The method of claim 18, further comprising:
(e) altering the emulsion conditions to reduce the ability of the surfactant to stabilize the emulsion, thereby demulsifying the emulsion.

20. The method of claim 19, further comprising:
(f) separating the demulsified oil-in-water emulsion into an oil fluid stream and a water fluid stream.

21. The method of claim 20, further comprising:
(g) recycling the water fluid stream.

22. A method for desludging an oil contaminated sediment, comprising:
(a) providing an aqueous surfactant solution comprising a tunable amphiphilic surfactant capable of emulsifying heavy crude oil components in the sediment;
(b) injecting the aqueous surfactant mixture into the sediment, thereby forming an oil-in-water emulsion comprising the heavy crude oil components of the contaminated sediment; and
removing the oil-in-water emulsion from the oil contaminated sediment, thereby desludging the oil contaminated sediment.
